(19) United States
(12) Patent Application Publication
(10) Pub. No.: US 2014/0174572 A1
(43) Pub. Date: Jun. 26, 2014

(54) TANK SYSTEM FOR A MOTOR VEHICLE

(71) Applicant: MAGNA STEYR Fuel Systems GesmbH, Sinabelkirchen (AT)

(72) Inventors: Bernd KAHLER, Graz (AT); Wolfgang VOGLMEIER, Guttaring (AT)

(73) Assignee: MAGNA STEYR Fuel Systems GesmbH, Sinabelkirchen (AT)

(21) Appl. No.: 14/084,383

(22) Filed: Nov. 19, 2013

(30) Foreign Application Priority Data
Nov. 30, 2012 (EP) EP 12195065.3

(51) Int. Cl. B60K 15/03

(52) U.S. Cl. CPC B60K 15/03
USPC 137/565.17

(57) ABSTRACT

A tank system for a motor vehicle, the tank system having a tank, a reservoir arranged in the tank, at least one supply line which fluidically connects the reservoir to the tank, and an extraction unit which is adapted to extract fuel from the reservoir via an engine feed line and deliver the fluid to a drive unit of the motor vehicle.

### CROSS-REFERENCE TO RELATED APPLICATIONS

The present application claims priority 35 U.S.C. §119 to European Patent Publication No. EP 13179536.1 (filed on Nov. 30, 2012), and European Patent Publication No. EP 12195065.3 (filed on Aug. 7, 2013), which are each hereby incorporated by reference in their respective entireties.

### TECHNICAL FIELD

Embodiments relate to a tank system for a motor vehicle. The tank system has a tank, a reservoir arranged in the tank, at least one supply line which fluidically connects the reservoir to the tank, and an extraction unit which is adapted to extract fluid such as fuel, for example, from the reservoir via an engine feed line and deliver the fluid to a drive unit of the motor vehicle.

### BACKGROUND

Tank systems are known whereby generally an open container serves as a reservoir. The container is arranged such that, in particular at low fill levels, the fuel collects in the container. For this for example a mushroom valve is arranged on the floor of the container.

Such a storage container is known, for example, from German Patent Publication No. DE 10 2007 039 861 A1 which discloses a fuel tank with at least one saddle, and with a baffle device provided in the region of the saddle. A delivery unit is arranged in the storage container which extracts fuel from the storage container and thus drives suction jet pumps. The storage container is filled, for example, by way a container suction jet pump.

European Patent Publication No. EP 0 976 602 A2 discloses a fuel tank with a reservoir arranged inside the fuel tank, with which a motorised pump is associated, and with a filler pipe through which the fuel flows into the fuel tank, wherein at least part of the fuel is guided directly into the reservoir. A return line returns the extracted surplus fuel into a chamber surrounding the reservoir, and at its outflow end is fitted with a propulsion nozzle of a suction jet pump, the capture nozzle of which forms the inflow end of an overflow pipe which opens into the reservoir.

### SUMMARY

Embodiments relate to an economic tank system for a motor vehicle which allows reliable operation even with a low fuel quantity in the tank system. In particular, the necessary initial fill quantity and the residual quantity of fuel in the tank system which may not be extracted are reduced.

In accordance with embodiments, a tank system for a motor vehicle includes at least one of: a tank, a reservoir arranged in the tank, an extraction unit which is adapted to extract fuel from the reservoir via an engine feed line and supply it to a drive unit of the motor vehicle, and at least one supply line which fluidically connects the reservoir to the tank, wherein the reservoir has a reservoir valve configured for fluidic connection to the tank via the reservoir valve, wherein the reservoir valve is operable between an open position in a normal operating mode in which the reservoir valve is surrounded by fuel in the tank, and closed position in a residual quantity mode in which the reservoir valve is not surrounded by fuel in the tank, wherein the reservoir is a container which in residual quantity mode is open exclusively at the engine feed line and at the at least one supply line.

In accordance with embodiments, in the normal operating mode in which sufficient fuel is still available in the tank, the reservoir of a tank system is therefore open towards the tank via the reservoir valve, so that fuel may be extracted from the tank by the extraction unit in the spatially adjacent to the reservoir and no vacuum occurs in the reservoir. In contrast, in the residual quantity mode in which insufficient fuel is present in the tank at the float valve so that the reservoir valve is closed, due to the extraction of fuel from the reservoir by way of the extraction unit, a vacuum occurs in the reservoir whereby fuel is drawn from the tank into the reservoir via the at least one supply line.

By suitable arrangement of the flow-side end or multiple ends of multiple supply lines in the tank, the fuel supply to the extraction unit and hence to the drive unit of the motor vehicle may be ensured even at low fuel quantities without having to use additional aids such as suction jet pumps.

In accordance with embodiments, in normal operating mode, the reservoir may be open at the engine feed line and at the reservoir valve.

In accordance with embodiments, in normal operating mode, he reservoir may also be open at the at least one supply line.

In accordance with embodiments, in normal operating mode, the reservoir may be open exclusively at the engine feed line, at the reservoir valve and the at the at least one supply line.

In accordance with embodiments, the reservoir valve is a float valve.

In accordance with embodiments, the reservoir is a flat container close to the floor of the tank.

In accordance with embodiments, the reservoir valve may in particular be arranged in a surge container in the tank so that the surge container may be fluidically connected to the reservoir via the reservoir valve.

In accordance with embodiments, the tank system may be filled via a filler pipe, in which the filler pipe opens into the surge container. Thus, the surge container, which may be located spatially above the reservoir, is already filled with fuel after refuelling so that fuel may be extracted via the reservoir valve.

In accordance with embodiments, a supply line float valve is arranged at the end of the supply line opening into the tank.

A tank system in accordance with embodiments may have at least two supply lines in order to extract fuel from different positions in the tank. The ends of the supply lines are then advantageously spatially distributed in the tank, so that even when the vehicle is on a slope or has separate tank regions and a low fuel level in the tank, where possible at least one end of a supply line is still surrounded by fuel. A float valve may be arranged at all ends of the supply lines.

In accordance with embodiments, the extraction unit includes a return line, and the return line opens into a return storage region which is preferably a separate region in the tank.

In accordance with embodiments, the reservoir has a device, in particular, a safety valve, which prevent the occurrence of a vacuum in the reservoir beyond a predefined maximum vacuum.

The safety valve may then particularly advantageously be fluidically connected to the return storage region. This ensures that if the safety valve reacts to a vacuum in the reservoir, fuel and not air is drawn into the vacuum region to keep the lines still filled.

The return storage region is preferably a separate portion of the surge container, in particular a laterally separate portion of the surge container.

In accordance with embodiments, a tank system may include at least one of: at least one second tank fluidically connected to the first tank or the reservoir via a connecting line. This allows the available tank volume to be increased. If the second tank is fluidically connected directly to the reservoir, fuel may be drawn directly from the additional tank via the connecting line by way of the vacuum in the reservoir. A separation in the liquid column in the connecting line is then avoided particularly efficiently, so that the principle of communicating vessels and a suction lever may be utilized.

In accordance with embodiments, a connecting line float valve may be arranged at the end of the connecting line opening into the tank. The connecting line may also, for example, via a T-piece in the second tank, open into the additional tank at multiple ends which may be each fitted with a float valve so that the second tank may also have multiple supply lines to the reservoir of the tank. Thus fuel may also be extracted from the second tank at different positions.

In accordance with embodiments, the first tank and/or the second tank has a device, in particular a purge valve, such as, for example, a roll-over valve, configured to prevent the occurrence of too great a vacuum in the first tank and/or the second tank. The tank system may be vented, for example, exclusively via the purge valve of the second tank so that too great a vacuum in the tank may be dissipated if necessary via the second tank. In particular, if the second tank is fluidically connected to the reservoir via the connecting line, the first tank and the second tank may have purge valves.

In accordance with embodiments, a tank system for a motor vehicle may include at least one of:

a tank; a reservoir arranged in the tank, the reservoir having a reservoir valve configured to fluidically connected the tank to the reservoir valve; an extraction unit which is fluidically connected to the reservoir and configured to extract a fluid from the reservoir via an engine feed line and supply the fluid to a drive unit of the motor vehicle; and at least one supply line which fluidically connects the reservoir to the tank, wherein the reservoir valve is operable between a normal operating mode in which the reservoir is in an open state and surrounded by the fluid in the tank, and a residual quantity mode in which the reservoir is in a closed state, not surrounded by the fuel in the tank, and open exclusively at the engine feed line and the at least one supply line.

In accordance with embodiments, a tank system for a motor vehicle may include at least one of: a tank; a reservoir arranged in the tank, the reservoir having a reservoir valve configured to fluidically connected the tank to the reservoir valve; an extraction unit which is fluidically connected to the reservoir and configured to extract a fluid from the reservoir via an engine feed line and supply the fluid to a drive unit of the motor vehicle; a first supply line which fluidically connects the reservoir to the tank at a first connection point; and a second supply line which fluidically connects the reservoir to the tank at a second connection point, wherein the reservoir valve is operable between a normal operating mode in which the reservoir is in an open state and surrounded by the fluid in the tank, and a residual quantity mode in which the reservoir is in a closed state, not surrounded by the fuel in the tank, and open exclusively at the engine feed line and the at least one supply line.

In accordance with embodiments, a tank system for a motor vehicle may include at least one of: a first tank; a second tank fluidically connected to the first tank; a reservoir arranged in the first tank, the reservoir having a reservoir valve configured to fluidically connected the first tank to the reservoir valve; an extraction unit which is fluidically connected to the reservoir and configured to extract a fluid from the reservoir via an engine feed line and supply the fluid to a drive unit of the motor vehicle; and a supply line which fluidically connects the reservoir to the first tank, wherein the reservoir valve is operable between a normal operating mode in which the reservoir is in an open state and surrounded by the fluid in the tank, and a residual quantity mode in which the reservoir is in a closed state, not surrounded by the fuel in the tank, and open exclusively at the engine feed line and the at least one supply line

### DRAWINGS

Embodiments will be illustrated by way of example in the drawings and explained in the description below.

FIG. 1 illustrates a hydraulic diagram of a tank system with a tank, in accordance with embodiments.

FIG. 2 is a hydraulic diagram of a tank system having first and second tanks in accordance with embodiments.

### DESCRIPTION

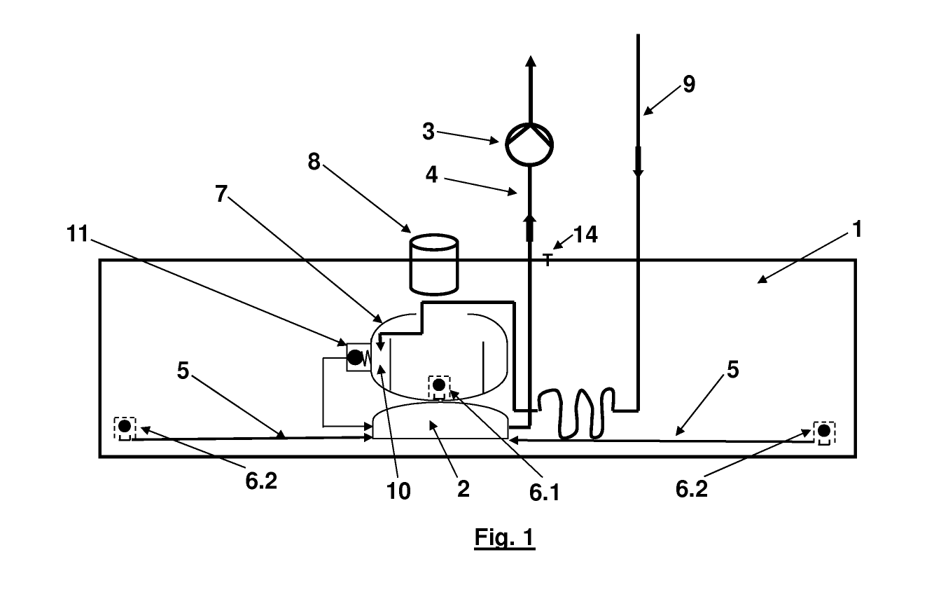

As illustrated in FIG. 1, a tank system for a motor vehicle includes a tank 1. A reservoir 2 is arranged in the tank 1 close to the floor of the tank 1. An extraction unit 3 which is fluidically connected to the reservoir 2 and configured to extract a fluid such as fuel from the reservoir 2 via an engine feed line 4 and supply the fluid to a drive unit of the motor vehicle.

A plurality of supply lines 5 fluidically connect the reservoir 2 to the tank 1. The ends of the supply lines 5 are spaced away from each other and spatially arranged at close to the floor of the tank 1. The ends of the supply lines 5 are each fitted with a supply line float valve 6.2. The reservoir 2 has a float valve as a reservoir valve 6.1, via which the reservoir 2 may be fluidically connected to the tank 1. The reservoir valve 6.1 is open in normal operating mode in which the reservoir valve 6.1 is surrounded by fuel in the tank 1, and closed in a residual quantity mode in which the reservoir valve 6.1 is not surrounded by fuel in the tank 1. In residual quantity mode, i.e., when the reservoir valve 6.1 is closed, the reservoir 2 is open exclusively at the engine feed line 4 and at the two supply lines 5. In normal operating mode, the reservoir valve 6.1 is also open. Thus, in normal operating mode, fuel may be extracted from the tank 1 by the extraction unit 3 via the reservoir 2 and the opened reservoir valve 6.1, or if the reservoir valve 6.1 is closed, via the supply lines 5.

The reservoir valve 6.1 may be spatially arranged or positioned on the floor of a surge container 7 which is spatially located above the reservoir 2. A filler pipe 8 is fluidically connected to the surge container 7, and opens spatially above the surge container 7 or in the surge container 7, so that the surge container 7 may be filled first when filling the tank system.

The extraction unit 3 includes a return line 9 which is fluidically connected to the surge container 7, and opens into a laterally separate portion of the surge container 7 which is formed as a return storage region 10.

A safety valve 11 is provided and configured to prevent the occurrence of too great a vacuum in the reservoir 2 beyond a predefined maximum vacuum, in that it opens at too great a vacuum. The safety valve 11 is fluidically connected to the return storage region 10 in a manner such that when the safety valve 11 is in open position, fuel may be extracted from the return storage region 10 via the extraction unit 3. The tank 1 may also include a roll-over valve 14 at an upper portion of the tank and spatially above the reservoir 2.

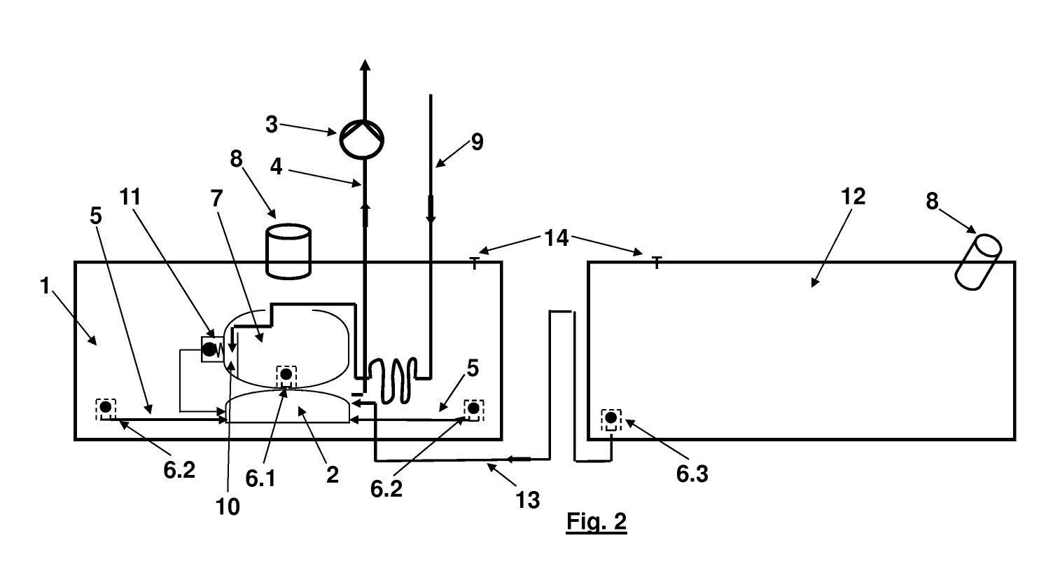

As illustrated in FIG. 2, in accordance with embodiments, a tank system in accordance with embodiments includes a primary tank 1 and a secondary tank 12 provided to increase the overall tank volume. The secondary tank 12 is fluidically connected to the primary tank 1 via a connecting line 13, so that on extraction of fuel by the extraction unit 3 from the tank 1, fuel may also reach the reservoir 2 via the connecting line 13 from the secondary tank 12. The connecting line 13 has two ends on the sides of the secondary tank 12 which, like the ends of the supply lines 5, are arranged close to the floor at different regions of the secondary tank 12. The end of the connecting line 13 has a further float valve, namely the connecting line float valve 6.3. The secondary tank 12 also has a filler tube 8 and a roll-over valve 14.

Embodiments thus allow reliable operation of a tank system for a motor vehicle even with low fuel quantities in the tank system.

The term “coupled” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SIGNS

1 Tank
2 Reservoir
3 Extraction unit
4 Engine feed line
5 Supply line
6.1 Reservoir valve
6.2 Supply line float valve
6.3 Connecting line float valve
7 Surge container
8 Filler pipe
9 Return line
10 Return storage region
11 Safety valve
12 Additional tank
13 Connecting line
14 Roll-over valve

What is claimed is:

1. A tank system for a motor vehicle, comprising:
a tank;
a reservoir arranged in the tank, the reservoir having a reservoir valve configured to fluidically connected the tank to the reservoir valve; and
an extraction unit which is fluidically connected to the reservoir and configured to extract a fluid from the reservoir via an engine feed line and supply the fluid to a drive unit of the motor vehicle;
at least one supply line which fluidically connects the reservoir to the tank,
wherein the reservoir valve is operable between a normal operating mode in which the reservoir is in an open state and surrounded by the fluid in the tank, and a residual quantity mode in which the reservoir is in a closed state, not surrounded by the fuel in the tank, and open exclusively at the engine feed line and the at least one supply line.

2. The tank system of claim 1, wherein the reservoir comprises a container.

3. The tank system of claim 1, wherein in the normal operating mode the reservoir is open at the engine feed line and at the reservoir valve.

4. The tank system of claim 1, wherein in the normal operating mode the reservoir is open at the engine feed line, at the reservoir valve and the at least one supply line.

5. The tank system of claim 1, wherein the reservoir valve comprises a float valve.

6. The tank system of claim 1, wherein the reservoir is a flat container spatially arranged adjacent to a bottom floor of the tank.

7. The tank system of claim 1, wherein the reservoir valve is spatially arranged in a surge container of the tank and fluidically connects the surge container to the reservoir.

8. The tank system of claim 7, further comprising a filler pipe fluidically connected to the tank and configured to open into the surge container.

9. The tank system of claim 1, further comprising a supply line float valve spatially arranged at an end of the at least one supply line and which opens into the tank.

10. The tank system of claim 1, wherein the extraction unit comprises a return line configured to open into a return storage region.

11. The tank system of claim 10, wherein the reservoir has a safety valve configured to prevent an occurrence of a vacuum in the reservoir beyond a predefined maximum vacuum.

12. The tank system of claim 11, wherein the safety valve is fluidically connected to the return storage region.

13. The tank system of claim 1, wherein:
wherein the reservoir valve is spatially arranged in a surge container of the tank and fluidically connects the surge container to the reservoir;
the extraction unit comprises a return line configured to open into a return storage region; and
the return storage region is a separate portion of the surge container.

14. The tank system of claim 1, wherein the tank has a roll-over valve configured to prevent an occurrence of a vacuum in the tank beyond a predefined maximum vacuum.

15. A tank system for a motor vehicle, comprising:
a tank;
a reservoir arranged in the tank, the reservoir having a reservoir valve configured to fluidically connected the tank to the reservoir valve;
an extraction unit which is fluidically connected to the reservoir and configured to extract a fluid from the reservoir via an engine feed line and supply the fluid to a drive unit of the motor vehicle;
a first supply line which fluidically connects the reservoir to the tank at a first connection point; and
a second supply line which fluidically connects the reservoir to the tank at a second connection point;
wherein the reservoir valve is operable between a normal operating mode in which the reservoir is in an open state and surrounded by the fluid in the tank, and a residual quantity mode in which the reservoir is in a closed state, not surrounded by the fuel in the tank, and open exclusively at the engine feed line and the at least one supply line.

16. A tank system for a motor vehicle, comprising:
a first tank;
a second tank fluidically connected to the first tank;
a reservoir arranged in the first tank, the reservoir having a reservoir valve configured to fluidically connected the first tank to the reservoir valve;
an extraction unit which is fluidically connected to the reservoir and configured to extract a fluid from the reservoir via an engine feed line and supply the fluid to a drive unit of the motor vehicle; and
a supply line which fluidically connects the reservoir to the first tank,
wherein the reservoir valve is operable between a normal operating mode in which the reservoir is in an open state and surrounded by the fluid in the tank, and a residual quantity mode in which the reservoir is in a closed state, not surrounded by the fuel in the tank, and open exclusively at the engine feed line and the at least one supply line.

17. The tank system of claim 16, further comprising a connecting line configured to fluidically connect the first tank to the second tank.

18. The tank system of claim 17, further comprising a connecting line float valve arranged at an end of the connecting line and configured to open into the second tank.

19. The tank system of claim 18, wherein:
the connecting line has a plurality of ends which open into the second tank; and
and each end of the connecting line has a corresponding connecting line float valve.

20. The tank system of claim 16, wherein at least one of the first tank and the second tank has a roll-over valve configured to prevent an occurrence of a vacuum in at least one of the first tank and the second tank beyond a predefined maximum vacuum.
